(19) United States
(12) Patent Application Publication
(10) Pub. No.: US 2025/0094788 A1
(43) Pub. Date: Mar. 20, 2025

(54) CROSS-RELEVANT REFINEMENT OF GENERATIVE ARTIFICIAL INTELLIGENCE MODELS FOR CREATIVE CONTENT ACROSS MULTIPLE PLATFORMS

(71) Applicant: Promoted.ai, Inc., San Francisco, CA (US)

(72) Inventor: Andrew Donald Yates, San Francisco, CA (US)

(21) Appl. No.: 18/823,451

(22) Filed: Sep. 3, 2024

Related U.S. Application Data
(60) Provisional application No. 63/538,904, filed on Sep. 18, 2023.

(51) Int. Cl. G06N 3/0475; G06N 3/045; G06N 3/096

(52) U.S. Cl. CPC G06N 3/0475; G06N 3/045; G06N 3/096

(57) ABSTRACT

Methods and systems provide for cross-relevant refinement of generative artificial intelligence models for creative content across multiple platforms. In one embodiment, the system receives creative content related to a first product listing for a product within a first platform, user engagement data for a user of a second platform, and one or more pieces of contextual information; trains a refinement of a second generative AI model for dynamic creative content generation for a modified version of the first product listing for the second platform; generates and displays one or more pieces of creative content for a second product listing to be published on the second platform; receives feedback regarding user engagement with the pieces of creative content in terms of whether an engagement objective has been achieved; and refines the first generative AI model and the second generative AI model via a network of cross-refinement.

### CROSS-REFERENCE TO RELATED APPLICATIONS

This application claims the benefit of priority to U.S. Provisional Application No. 63/538,904, filed on Sep. 18, 2023, which is hereby incorporated by reference in its entirety.

### FIELD OF INVENTION

Various embodiments relate generally to content generation, and more particularly, to systems and methods for providing cross-relevant refinement of generative artificial intelligence models for creative content across multiple platforms.

### SUMMARY

The appended claims may serve as a summary of this application.

### BRIEF DESCRIPTION OF THE DRAWINGS

The present invention relates generally to content generation, and more particularly, to systems and methods for providing cross-relevant refinement of generative artificial intelligence models for creative content across multiple platforms.

The present disclosure will become better understood from the detailed description and the drawings, wherein:

FIG. 1A is a diagram illustrating an exemplary environment in which some embodiments may operate.

FIG. 1B is a diagram illustrating an exemplary computer system that may execute instructions to perform some of the methods herein.

FIG. 2 is a flow chart illustrating an exemplary method that may be performed in some embodiments.

FIG. 3A is a diagram illustrating one example embodiment of creative content generated for a product listing, in accordance with some embodiments of the invention.

FIG. 3B is a diagram illustrating the versatility of the model refinement approaches in generating product listings for different platforms or environments based on a product listing for a first platform, in accordance with some embodiments of the invention.

FIG. 4 is a diagram illustrating an exemplary computer that may perform processing in some embodiments.

### DETAILED DESCRIPTION

In this specification, reference is made in detail to specific embodiments of the invention. Some of the embodiments or their aspects are illustrated in the drawings.

For clarity in explanation, the invention has been described with reference to specific embodiments, however it should be understood that the invention is not limited to the described embodiments. On the contrary, the invention covers alternatives, modifications, and equivalents as may be included within its scope as defined by any patent claims. The following embodiments of the invention are set forth without any loss of generality to, and without imposing limitations on, the claimed invention. In the following description, specific details are set forth in order to provide a thorough understanding of the present invention. The present invention may be practiced without some or all of these specific details. In addition, well known features may not have been described in detail to avoid unnecessarily obscuring the invention.

In addition, it should be understood that steps of the exemplary methods set forth in this exemplary patent can be performed in different orders than the order presented in this specification. Furthermore, some steps of the exemplary methods may be performed in parallel rather than being performed sequentially. Also, the steps of the exemplary methods may be performed in a network environment in which some steps are performed by different computers in the networked environment.

Some embodiments are implemented by a computer system. A computer system may include a processor, a memory, and a non-transitory computer-readable medium. The memory and non-transitory medium may store instructions for performing methods and steps described herein.

The ability to produce effective creative content that resonates with users across multiple platforms has become increasingly paramount. As businesses strive to maintain a strong online presence, the demand for tailored and contextually relevant content has surged. To meet this demand, various methods and technologies have emerged, each with its own set of strengths and limitations.

One of the prevailing methods in content generation relies on the use of platform-specific optimization algorithms. These algorithms aim to fine-tune creative content for individual platforms, accounting for variations in user behavior, engagement patterns, and platform-specific features. While effective to some extent, these methods often require manual intervention and extensive testing, making them time-consuming and resource-intensive. Additionally, they may not fully capitalize on the potential for cross-platform synergy, resulting in a fragmented approach to content generation.

The limitations of current solutions are particularly pronounced when it comes to generating creative content that not only aligns with the platform's requirements but also adapts to diverse user contexts. This adaptability is crucial for maintaining user engagement and achieving desired outcomes, such as increased sales or interaction with content elements. Existing methods often lack the ability to seamlessly transfer and refine creative content across platforms, hindering the efficiency and effectiveness of content generation efforts.

In the rapidly evolving digital ecosystem, there is a need for a more sophisticated and integrated approach to creative content generation. The ability to refine and adapt content dynamically for diverse platforms and contexts is a critical frontier in the field of content generation, promising more effective and efficient strategies for engaging with users in the digital realm.

In one embodiment, the system receives one or more initial pieces of creative content related to a first product listing for a product within a first platform, user engagement data for a user of a second platform, and one or more pieces of contextual information related to how the product will be viewed within the second platform; uses the one or more initial pieces of creative content, the user engagement data, and the one or more pieces of contextual information to train a refinement of a second generative AI model for dynamic creative content generation for a modified version of the first product listing for the second platform; uses the trained second generative AI model to generate one or more pieces of creative content for a second product listing to be published on the second platform; displays the one or more pieces of creative content for the second product listing to be viewed on the second platform via a client device associated with the user; receives feedback regarding user engagement with the pieces of creative content in terms of whether an engagement objective has been achieved; and refines the first generative AI model and the second generative AI model based on the received feedback, the refinement being performed via a network of cross-refinement.

Further areas of applicability of the present disclosure will become apparent from the remainder of the detailed description, the claims, and the drawings. The detailed description and specific examples are intended for illustration only and are not intended to limit the scope of the disclosure.

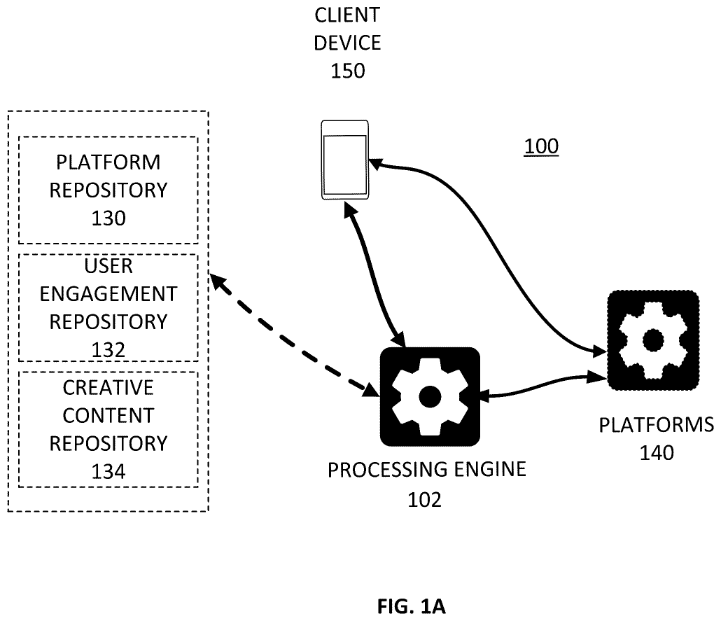

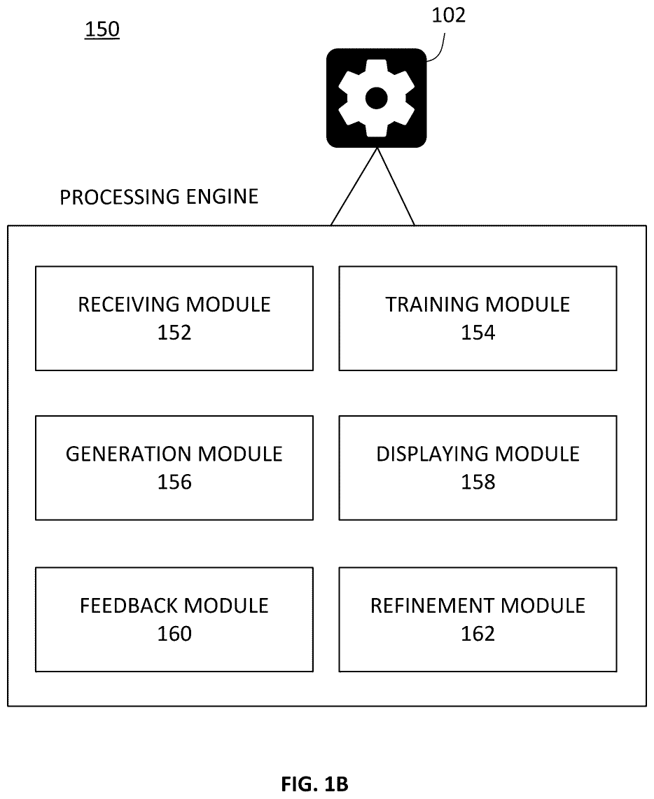

FIG. 1A is a diagram illustrating an exemplary environment in which some embodiments may operate. In the exemplary environment 100, a client device 150, and multiple platforms 140 are connected to a processing engine 102. The processing engine 102 is optionally connected to one or more repositories and/or databases. Such repositories and/or databases may include, for example, a platform repository 130, a user engagement repository 132, and a creative content repository 134. One or more of such repositories may be combined or split into multiple repositories. The client device 150 in this environment may be a computer, and the platforms 140 and processing engine 102 may be, in whole or in part, applications or software hosted on a computer or multiple computers which are communicatively coupled via remote server or locally.

The exemplary environment 100 is illustrated with only one client device and one processing engine, though in practice there may be more or fewer additional client devices and/or processing engines. In some embodiments, the client device, platforms, and processing engine may be part of the same computer or device.

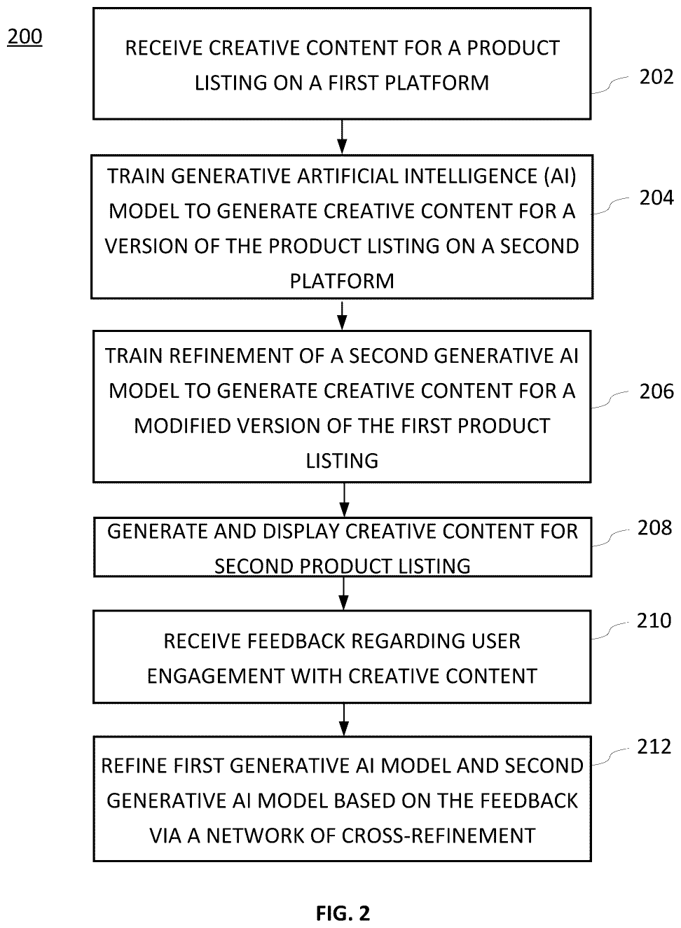

In an embodiment, the processing engine 102 may perform the method 200 (FIG. 2) or other method herein and, as a result, provide for cross-relevant refinement of generative artificial intelligence models for creative content across multiple platforms. In some embodiments, this may be accomplished via communication with the client device, additional client device(s), processing engine 102, platforms 140, and/or other device(s) over a network between the device(s) and an application server or some other network server. In some embodiments, one or both of the processing engine 102 and platforms 140 may be an application, browser extension, or other piece of software hosted on a computer or similar device, or in itself a computer or similar device configured to host an application, browser extension, or other piece of software to perform some of the methods and embodiments herein.

In some embodiments, the processing engine 102 performs processing tasks partially or entirely on the client device 102 in a manner that is local to the device and relies on the device's local processor and capabilities. In some embodiments, the processing engine 102 may perform processing tasks in a manner such that some specific processing tasks are performed locally, such as, e.g., visual AI processing tasks, while other processing tasks are performed remotely via one or more connected servers. In yet other embodiments, the processing engine 102 may processing tasks entirely remotely.

In some embodiments, client device 150 may be a device with a display configured to present information to a user of the device. In some embodiments, the client device 150 presents information in the form of a user interface (UI) with UI elements or components. In some embodiments, the client device 150 sends and receives signals and/or information to the processing engine 102 pertaining to the communication platform. In some embodiments, client device 150 is a computer device capable of hosting and executing one or more applications or other programs capable of sending and/or receiving information. In some embodiments, the client device 150 may be a computer desktop or laptop, mobile phone, virtual assistant, virtual reality or augmented reality device, wearable, or any other suitable device capable of sending and receiving information. In some embodiments, the processing engine 102 and/or platforms 140 may be hosted in whole or in part as an application or web service executed on the client device 150. In some embodiments, one or more of the communication platform 140, processing engine 102, and client device 150 may be the same device. In some embodiments, the platforms 140 and/or the client device 150 are associated with one or more particular user accounts.

In some embodiments, optional repositories function to store and/or maintain, respectively, information on different platforms or environments for hosting product listings, user engagement data, and creative content generated for product listings. The optional repositories may also store and/or maintain any other suitable information for the processing engine 102 to perform elements of the methods and systems herein pertaining to the platform. In some embodiments, the optional database(s) can be queried by one or more components of system 100 (e.g., by the processing engine 102), and specific stored data in the database(s) can be retrieved.

FIG. 1B is a diagram illustrating an exemplary computer system 150 with software modules that may execute some of the functionality described herein. In some embodiments, the modules illustrated are components of the processing engine 102.

Receiving module 152 functions to receive one or more initial pieces of creative content related to a first product listing for a product within a first platform, user engagement data for a user of a second platform, and one or more pieces of contextual information related to how the product will be viewed within the second platform.

Training module 154 functions to use the one or more initial pieces of creative content, the user engagement data, and the one or more pieces of contextual information to train a refinement of a second generative AI model for dynamic creative content generation for a modified version of the first product listing for the second platform.

Generation module 156 functions to use the trained second generative AI model to generate one or more pieces of creative content for a second product listing to be published on the second platform.

Displaying module 158 functions to display the one or more pieces of creative content for the second product listing to be viewed on the second platform via a client device associated with the user.

Feedback module 160 functions to receive feedback regarding user engagement with the pieces of creative content in terms of whether an engagement objective has been achieved.

Refinement module 162 functions to refine the first generative AI model and the second generative AI model based on the received feedback, the refinement being performed via a network of cross-refinement.

The functionality of the above modules will be described in further detail with respect to the exemplary method of FIG. 2A below.

FIG. 2A is a flow chart illustrating an exemplary method that may be performed in some embodiments.

At step 202, the system receives one or more initial pieces of creative content related to a first product listing for a product within a first platform, user engagement data for a user of a second platform, and one or more pieces of contextual information related to how the product will be viewed within the second platform.

First, the system receives one or more initial pieces of creative content that are associated with a specific product listing for a product. In some embodiments, these initial pieces of creative content are generated by a first generative artificial intelligence (hereinafter “AI”) model, which may be, for example, a large language model (hereinafter “LLM”) or a similar AI architecture.

Second, user engagement data is collected for a user who interacts with a second platform. In various embodiments, this data includes various signals and information related to the user's engagement with content and products on the second platform. In various embodiments, such data could encompass a range of metrics, including, for example, click-through rates, dwell times, purchase history, and/or interaction patterns with interactive elements.

Third, the system gathers one or more pieces of contextual information that provide insights into how the product associated with the creative content will be perceived and utilized within the second platform. In various embodiments, this contextual information may take into account factors such as, e.g., the user's geographic location, the time of day, and/or the specific search query used. It provides critical context for tailoring the creative content to align with the user's preferences and the platform's requirements.

At step 204, the system uses the one or more initial pieces of creative content, the user engagement data, and the one or more pieces of contextual information to train a refinement of a second generative AI model for dynamic creative content generation for a modified version of the first product listing for the second platform. In some embodiments, this process begins with the utilization of the initial pieces of creative content, which serve as the baseline or reference material. These initial content pieces are products of the first generative AI model and represent the original creative assets associated with the product listing on the first platform. In some embodiments, the system next incorporates the user engagement data collected from the second platform. This data provides insights into how users on the second platform interact with, e.g., content, products, and interactive elements. In some embodiments, the system additionally takes into account the contextual information related to how the product will be viewed within the second platform.

By combining these three key components—initial creative content, user engagement data, and contextual information—the system refines the second generative AI model. In some embodiments, this refined second generative AI model is optimized to generate creative content that is not only suitable for the second platform, but is also highly responsive to user behavior and preferences within that platform's context. It ensures that the creative content aligns with the platform's specific requirements and user expectations, ultimately enhancing user engagement and the overall effectiveness of the product listing within the second platform.

In some embodiments, the training involves backpropagating a loss function to predict the likelihood of the pieces of creative content resulting in achieving the engagement objective. Backpropagation is used to optimize the models by minimizing a loss function associated with the likelihood of the pieces of creative content leading to the achievement of the engagement objective. The key objective of the training is to enable the generative AI models to learn and improve their content generation capabilities. To do this, a loss function is defined, which quantifies how far off the generated content is from achieving the desired engagement objective. The loss function takes into account various factors, including user engagement data and contextual information. In this context, the first and second generative AI models are refined by updating their parameters based on the feedback provided by the loss function.

In some embodiments, the system using the loss function to predict the likelihood that the generated pieces of creative content will lead to the achievement of the engagement objective. By minimizing this loss function through backpropagation, the generative AI models become better at generating content that is more likely to result in user engagement.

In some embodiments, at least one of the first and second generative AI models is a large LLM. An LLM is a type of artificial intelligence model that is specifically designed to process and generate human language. These models are characterized by their extensive training on vast corpora of text data, allowing them to understand and generate text in a coherent and contextually relevant manner. In various embodiments, LLMs can be leveraged in various ways to enhance the effectiveness of the creative content being generated.

In various embodiments, LLMs can be used for one or more of: creating compelling product titles, descriptions, and/or promotional messages; adapting the tone of the content based on user engagement data and contextual information; ensuring that the generated text resonates with the target audience; analyzing and understanding natural language queries, reviews, comments, conversations, and feedback from users related to products; generating content in multiple languages based on geographical location; analyzing user engagement data to understand individual preferences; employing sentiment analysis to gauge user sentiment towards products and tailor content accordingly; identifying relevant keywords and phrases that are currently trending or commonly used in the platform; generating diverse content variations for the same product; creating multiple versions of creative content for A/B testing; and any other relevant purpose an LLM may be used for.

At step 206, the system uses the trained second generative AI model to generate one or more pieces of creative content for a second product listing to be published on the second platform. The generated content pieces are intended for a second product listing that will be published on the second platform.

In some embodiments, the trained model utilizes the knowledge acquired during its refinement, incorporating insights from the initial creative content, user engagement data, and contextual information specific to the second platform. This allows it to generate creative content that is not only aligned with the product and its intended messaging, but also optimized for the unique characteristics and preferences of users on the second platform.

The generated creative content may encompass various elements such as, for example, product titles, descriptions, images, and promotional elements. In some embodiments, each element is carefully crafted to resonate with the audience on the second platform, considering factors such as, for example, the platform's user base, regional demographics, and the user's current context.

In some embodiments, the system adapts and modifies the creative content in real-time, responding to changes in user behavior and platform dynamics. This adaptability is a key advantage, as it allows the content to remain effective and aligned with user expectations as the platform evolves over time. Ultimately, the system's use of the trained model results in highly tailored and responsive creative content for the second product listing, enhancing the overall user experience and engagement within the second platform.

The term “creative content” encompasses various elements that contribute to an appealing product listing. These elements can include, e.g., product titles, descriptions, and images. In some embodiments, the generative AI model's dynamic generation capabilities mean that it can adapt these elements based on the specific circumstances of the user and the product to generate different pieces of creative content for the same product listing, depending on, e.g., different contexts or users with differing preferences or engagement behaviors. For example, the generative AI model may generate different product titles for morning and evening shoppers, or tailor product descriptions differently to resonate with two different users located in different geographic regions.

In some embodiments, the generative AI model's ability to generate multiple pieces of creative content is advantageous. It provides flexibility for testing different approaches and variations to determine what resonates most effectively with users. In some embodiments, this process of content generation and testing is iterative, contributing to the continuous refinement of product listings, improving their overall performance.

In some embodiments, the piece of creative content is generated by the generative AI model to differ from one or more additional product listings presented concurrently to the user. In some embodiments, the generated piece of creative content is generated at least in part with an objective to compete with other concurrent listings within the environment to prevent all concurrent listings from having too-similar creative content. In some embodiments, the generated piece of creative content is generated at least in part to satisfy an objective of diversity in creative content with respect to concurrent listings within the environment according to user perception.

By producing creative content that highlights unique niches or features of a product that other products lack, the system can capture users' attention and encourage them to explore further. To achieve this differentiation, the system's generative AI model strategically analyzes the competition. It assesses the creative content of other listings, considering factors like product descriptions, titles, and images. The system then leverages this information to generate creative content that sets the product apart from the competition. For example, if several listings offer similar smartphones, the system may choose to highlight unique features of a particular phone, such as its advanced camera technology or exceptional battery life. By doing so, the generated content ensures that each listing offers something distinct, preventing redundancy and aiding users in making informed decisions.

In another example, if a user has shown a preference for eco-friendly products, the system can emphasize the environmental benefits of a particular product in its creative content, differentiating it from other listings. This tailored approach ensures that the creative content aligns with the user's interests and stands out among competing listings.

In some embodiments, the system can identify specific niches or unique selling points of a product and emphasize these in the creative content. For example, if a pair of running shoes has superior shock-absorption technology, the system can highlight this feature, especially if other concurrently presented listings lack such technology. By showcasing distinctive product attributes that cater to specific user needs, the system maximizes the likelihood of engagement and conversion.

In some embodiments, the creative content is dynamically generated or modified in real time to be competitive in achieving the engagement objective with other pieces of creative content in concurrent product listings within the second platform. In some embodiments, the AI models continuously adapt and refine the creative content to remain competitive amid the ever-changing landscape of concurrent product listings within the second platform. This dynamic approach involves real-time adjustments to the content to maximize its effectiveness in attracting user engagement and achieving the specified engagement objective. In some embodiments, the system actively monitors and responds to the performance of the creative content in comparison to other pieces of content appearing alongside concurrent product listings. If a piece of creative content is not performing well or is being outperformed by others, the AI models can swiftly generate modifications to improve its competitiveness.

In some embodiments, the second generative AI model is configured to generate the creative content in order to deliver the creative content in a different context from an initial received context for the first product listing. “Context” refers here to the circumstances or environment in which the creative content is presented to users. The first product listing may have been created for a specific platform or context, but the second generative AI model is capable of adapting this content for use in a different context.

This capability is valuable because it allows the system to repurpose and optimize creative content across various platforms or scenarios. For example, if the initial product listing was designed for a daytime viewing context, the second generative AI model can modify the content to make it more suitable for, e.g., nighttime viewing, a different platform, or any other context.

At step 208, the system displays the one or more pieces of creative content for the second product listing to be viewed on the second platform via a client device associated with the user. In some embodiments, the creative content is specifically tailored for the second platform and the user's context. It is strategically presented on the user's client device within the second platform's interface.

The user, while interacting with the second platform, will have the opportunity to view and engage with the displayed creative content. In various embodiments, this interaction can include actions such as, for example, clicking on a product listing, viewing additional details, or making a purchase, depending on the user's preferences and the content's effectiveness.

In some embodiments, the timing of when content is displayed to the user is also taken into consideration when presenting the content. In such embodiments, the content is presented to the user at the right moment to maximize its impact. For example, if a user is in the middle of exploring a product category, the relevant content may be displayed immediately to capture their attention and guide their decision-making process.

At step 210, the system receives feedback regarding user engagement with the pieces of creative content in terms of whether an engagement objective has been achieved. In some embodiments, the feedback encompasses a range of user interactions and behaviors within the second platform. It gauges the extent to which the user engages with the creative content, such as, for example, clicking on the product listing, viewing additional details, initiating a purchase, or other relevant actions. These interactions are indicative of the user's level of interest and engagement with the product listing.

In some embodiments, the system carefully monitors these user behaviors and tracks whether they align with the specified engagement objectives. For example, if the primary objective is to increase product sales, the feedback mechanism assesses whether users are making purchases after viewing the creative content. Similarly, if the objective is to encourage user interaction with interactive elements, the feedback measures the frequency and depth of these interactions.

In some embodiments, this feedback-driven approach allows for real-time evaluation and adjustment of the creative content strategy on the second platform. If the engagement objectives are not met, the system can adapt and refine the content generation process, making necessary modifications to improve user engagement and achieve the desired outcomes.

In various embodiments, engagement objectives can vary depending on the context. In some embodiments, the engagement objective revolves around user interaction and response to the displayed content. For instance, if the objective is to increase product sales, the feedback might focus on whether the user has made a purchase of the product in question after viewing the generated creative content, or added the corresponding product to an e-commerce cart after viewing the generated creative content. In some embodiments, if the goal is to encourage interaction, feedback may include data on, e.g., user clicks, taps, or other interactions with the content.

In some embodiments, the feedback received from users can help identify user preferences and trends, allowing for the adaptation of content strategies to better align with user expectations. For example, if users consistently respond positively to certain types of content, the generative AI model can be adjusted to generate more of that content.

In some embodiments, the system selects, via a model trainer, the engagement objective to be achieved. The model trainer is responsible for making decisions regarding the engagement objective that the system should focus on for a particular scenario or use case. In some embodiments, the system is configured to adapt and select the most relevant engagement objective based on the specific context or requirements. This adaptability is essential because different situations may call for different objectives. For instance, in some cases, the primary goal may be to boost sales, while in others, it might be to encourage user interactions with interactive elements within the listing.

At step 212, the system refines the first generative AI model and the second generative AI model based on the received feedback, the refinement being performed via a network of cross-refinement. In some embodiments, the two models collaboratively evolve and adapt to enhance their performance in generating effective creative content.

In some embodiments, the initial step in this cross-refinement network is the analysis of the feedback data. The system dissects the feedback to understand which aspects of the creative content contributed to or hindered the achievement of engagement objectives on the second platform. This analysis identifies strengths and weaknesses in the content generated by the second generative AI model. Subsequently, the findings from this analysis are not limited to optimizing the second generative AI model alone. Instead, a bi-directional flow of refinements is established between the first and second models. Both models undergo adjustments to improve their respective content generation processes.

For example, if the feedback highlights that certain creative elements or contextual factors significantly impact user engagement on the second platform, these insights are shared with the first generative AI model. The first model can then incorporate these findings into its own content generation for the first platform, thus refining its ability to produce effective content tailored to that environment. Conversely, the first model, which has been trained on a different platform, might bring innovative strategies or approaches to content generation that can benefit the second model. These insights may involve leveraging different types of product information or creative styles.

In some embodiments, the cross-refinement network continually exchanges information and insights between the two models. As a result, both models evolve iteratively, learning from each other's experiences and improving their creative content generation capabilities. This collaborative refinement approach ensures that the creative content generated by each model remains adaptive, contextually relevant, and optimized for achieving engagement objectives on their respective platforms.

In various embodiments, optimization may take several forms, depending on the nature of the feedback and the objectives. In some embodiments, optimization may include content modification. If the feedback indicates that certain aspects of the creative content are not resonating with users, for example, the generative AI model can be adjusted to modify those elements in future generation of creative content, or in generating alternate versions of the creative content for this product listing. This might involve, for example, changing the wording of a product description, adjusting image choices, or altering the overall layout to better capture user attention. In some embodiments, elements of the creative content may be added or removed.

In some embodiments, the underlying algorithms of the generative AI model can be fine-tuned based on feedback. This could include, for example, changes to how the model prioritizes different input data (e.g., product facts, user engagement data, and/or contextual information) or how it generates creative content based on specific user demographics or preferences. In some embodiments, the system may determine that the engagement objective needs to be reevaluated based on the user feedback or engagement data. For example, if the original objectives prove unattainable or unrealistic, they can be adjusted to better reflect the actual user behavior and expectations.

In some embodiments, the refining is performed to achieve the engagement objective for the second product listing being for a different product than for the first product listing. The refinement process begins by receiving the initial pieces of creative content for the first product listing, generated by the first generative AI model, user engagement data for a user of the second platform, and contextual information pertinent to how the product will be perceived within the second platform. While the initial creative content may be tailored to the first product listing, the feedback obtained from user engagement on the second platform serves as a valuable resource for enhancing content generation for a different product on the second platform.

As the refinement process unfolds, the second generative AI model is trained with the amalgamation of these inputs. This training facilitates the generation of creative content that is specifically optimized for the second product listing, even if it is distinct from the first product. The engagement objective for the second product listing, which could involve, for example, sales, interactions, or user viewing, is meticulously pursued throughout this process.

Once the second generative AI model is trained and ready, it commences generating one or more pieces of creative content for the second product listing, taking into account the user engagement data and contextual information acquired from the second platform. This content is designed to resonate with the users of the second platform, entice their engagement, and fulfill the specified engagement objectives.

In some embodiments, the feedback loop plays a pivotal role in this refinement process, assessing the effectiveness of the content generated for the second product listing. If the engagement objectives are met, the refinement has succeeded in optimizing content generation for a different product on the second platform. This adaptive and dynamic approach ensures that the system can efficiently generate engaging creative content for a wide array of products, catering to the unique demands and characteristics of each product listing on the second platform.

In some embodiments, the refining is performed via one or more transfer learning techniques. Transfer learning techniques are a class of machine learning methods that leverage knowledge gained from one task and apply it to improve performance on another, related task. In the context of this invention, transfer learning techniques can be used to adapt the generative AI models to generate creative content for a different product listing on the second platform.

In some embodiments, the refinement process begins by receiving initial pieces of creative content for the first product listing, which may be distinct from the second product. User engagement data from the second platform and contextual information relevant to the second product listing are also collected.

Transfer learning techniques come into play during the training phase of the second generative AI model. In some embodiments, the knowledge, patterns, and insights acquired by the first generative AI model in generating creative content for the first product listing are transferred, to some extent, to the second model. This transfer allows the second model to inherit valuable insights and strategies, even though it is generating content for a different product. As a result, the second generative AI model is able to adapt more swiftly and effectively to the demands of the second product listing, benefiting from the prior experience and expertise of the first model. This not only accelerates the refinement process but also enhances its overall efficacy, ensuring that the creative content generated for the second product listing is optimized for user engagement.

In some embodiments, the refining is performed to predict the likelihood that the user will interactively engage with the second product listing to achieve the engagement objective. The refinement process begins with the receipt of initial pieces of creative content related to the first product listing generated by the first generative AI model. Alongside this content, user engagement data for users of the second platform and contextual information related to the second product listing are gathered. This information forms the basis for the subsequent refinement.

In some embodiments, to achieve this, the first and second generative AI models undergo a process of cross-refinement. This entails leveraging the knowledge and insights gained from the first model's experience in generating content for the first product listing and applying it to the second model's context. In some embodiments, the system fine-tunes the second generative AI model's creative content generation capabilities in a way that enhances its ability to predict user engagement.

In some embodiments, the first generative AI model and second generative AI model are coupled together through an interface to generate cross-relevant creative content for the product listing. In various embodiments of the invention, the two AI models, namely the first generative AI model and the second generative AI model, are designed to work in tandem. They are connected or coupled together through an interface that enables them to share information and cooperate in generating creative content. The primary purpose of this coupling is to ensure that the creative content generated for a product listing on one platform (represented by the first generative AI model) can be refined and modified effectively for a different platform (represented by the second generative AI model). This process of cross-relevant content generation is critical for achieving optimal user engagement and performance on the second platform.

In some embodiments, the interface between these AI models facilitates the exchange of information, data, or insights that are relevant to the generation of creative content. This could include data related to user engagement, contextual information about the second platform, and the initial creative content generated by the first model.

In some embodiments, both the first generative AI model and the second generative AI model are used in sequence to generate creative content that is optimized for both the first and second platforms. In certain embodiments of the invention, a sequential approach is employed in which both AI models work in tandem to generate creative content. This process begins with the first generative AI model generating initial creative content for a product listing on the first platform. This initial content serves as a starting point and may be tailored to the specific conditions and requirements of the first platform.

Subsequently, the second generative AI model comes into play. It takes the initial creative content generated by the first model and refines it to suit the second platform. This refinement process considers factors such as user engagement data, contextual information about the second platform, and the engagement objectives set for the second platform. The outcome is creative content that is not only platform-specific but also optimized for achieving the desired engagement objectives on the second platform. The sequential use of both models ensures that the creative content retains its relevance and effectiveness when adapted from one platform to another. This approach acknowledges that different platforms may have distinct user behaviors, preferences, and presentation requirements.

In some embodiments, a sequence of tokens is generated to minimize the loss function of both generative AI models to generate creative content that is personalized and contextually aware for the user across both the first and second platforms. In some embodiments, the method involves a token generation approach. It begins with the selection of an initial set of tokens, often derived from the first generative AI model's output. These tokens serve as the foundation for the creative content. However, to enhance personalization and context-awareness, additional tokens are generated and incorporated into the content.

The generation of these additional tokens is driven by an objective to minimize the loss function of both generative AI models. This loss function quantifies the discrepancy between the generated content and the desired outcome, which, in this case, is user engagement aligned with the engagement objectives.

As the token sequence is iteratively expanded and refined, it becomes increasingly tailored to the user's preferences, the context of the second platform, and the engagement objectives set for that platform. By minimizing the loss function of both AI models, the system fine-tunes the creative content to maximize its effectiveness in engaging the user, regardless of whether they are interacting with the first or second platform.

In some embodiments, the first and second generative AI models are each trained separately and then concatenated to generate the creative content for the e-commerce listing. In some embodiments, the method follows a two-step process. Firstly, the first generative AI model is trained independently, focusing on its specific domain or platform, such as the first e-commerce platform. This training allows the model to become proficient in generating creative content tailored to the unique characteristics and requirements of that platform.

Similarly, the second generative AI model undergoes its training process independently. This training is specific to the second e-commerce platform, ensuring that it becomes adept at generating content optimized for that platform's particular context and user engagement objectives. Once both models have been trained individually and have acquired expertise in their respective domains, they are concatenated or combined. This concatenation process merges the capabilities of both models into a unified framework for generating creative content.

In some embodiments, each of the generative AI models have multiple tasks and multiple predictions for generating creative content. In some embodiments, both the first and second generative AI models are designed to handle a multitude of tasks and make multiple predictions during the creative content generation process. The use of multiple tasks and predictions within each model allows for a more comprehensive and nuanced approach to creative content generation. For example, the models may simultaneously predict user engagement metrics, such as, e.g., click-through rates, conversion rates, or user interaction patterns, while also considering various aspects of the product listings, such as, e.g., product descriptions, titles, and images.

In some embodiments, each of the first and second generative AI models generate separate objectives for generating or modifying the creative content to achieve the engagement objective across the first and second platforms. In some embodiments, each AI model operates with a degree of autonomy and adaptability. They assess the specific requirements and context of their respective platforms and generate objectives accordingly. These objectives may pertain to various aspects of creative content, such as optimizing product titles, descriptions, images, or interactive elements. By allowing each AI model to generate its own objectives, the system can ensure that the creative content is finely tuned to suit the unique characteristics and user expectations of each platform. For example, the first AI model may prioritize maximizing user interactions on a social media platform, while the second AI model may focus on driving direct sales on an e-commerce website.

In some embodiments, the first and second generative AI models are implemented to generate or modify creative content that achieves a standardized engagement objective between both generative AI models. In some embodiments, the AI models are designed to work collaboratively with a common engagement objective in mind. This standardized objective ensures consistency and alignment in the generated creative content, regardless of the platform. For instance, if the standardized engagement objective is to maximize user interactions and product sales, both AI models will generate or modify content with this goal as their primary focus. By adhering to a standardized engagement objective, the system can streamline content generation processes and maintain a cohesive brand identity or marketing strategy across various platforms. It also simplifies the management of engagement metrics and allows for easier comparison of content performance between platforms.

In some embodiments, the first and second generative AI models are used for generating creative content based on awareness of what other creative content is present for concurrent product listings within the respective platform. In some embodiments, the AI models are aware of and take into account the creative content generated by other sources for concurrent product listings on the platform. This awareness allows the AI models to make informed decisions about the content they generate or modify, ensuring that it stands out and complements, rather than duplicates or conflicts with, the content associated with other product listings. By considering the context of the platform and the competitive landscape of creative content, the AI models can optimize their output to achieve the defined engagement objective effectively. This approach helps prevent content redundancy or over-saturation, enhancing the overall user experience and increasing the likelihood of achieving engagement goals.

In some embodiments, the first and second generative AI models are configured to generate or modify creative content to be displayed in a cross-channel promotional product listing across a plurality of platforms. In this context, “cross-channel promotional product listings” refers to product listings that are intended for promotion or display across various marketing channels or platforms simultaneously. These channels or platforms could include, for example, e-commerce websites, social media platforms, email marketing campaigns, mobile apps, and more.

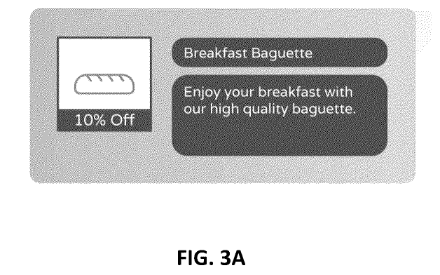

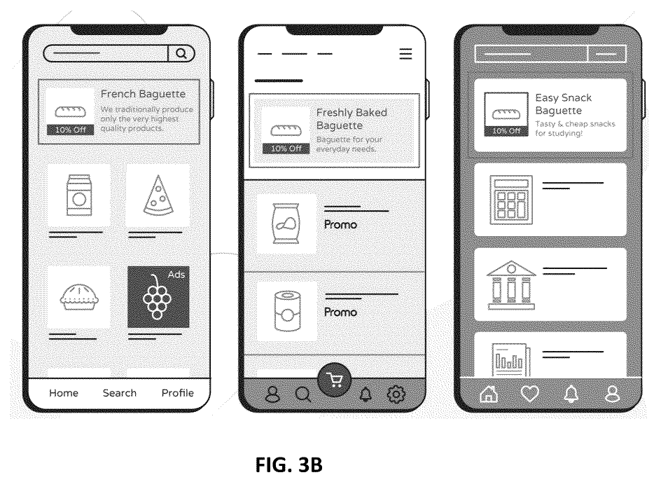

FIG. 3A is a diagram illustrating one example embodiment of creative content generated for a product listing, in accordance with some embodiments of the invention. The depicted creative content is designed to showcase a product, specifically a baguette, and to convey appealing and engaging information to potential customers.

In this illustrative example, an image of the baguette takes center stage, occupying a prominent portion of the creative content. In some embodiments, the image is a photo or visual depiction of the product that has been provided as part of the initial product facts, while in other embodiments, the image is dynamically generated by the generative AI model as part of the rich media generated for the creative content. Below the image, a clear and attention-grabbing promotional element is presented. The words “10% off” are prominently displayed, conveying a special offer to potential customers. This discount information is strategically placed to capture the viewer's attention and create a sense of value.

To the right of the image and the promotional offer, the product title and description are shown. The product title reads “Breakfast Baguette,” succinctly identifying the product and providing clarity to potential buyers. The choice of a descriptive and appetizing title aims to engage the audience and communicate the product's purpose. In this example, contextual information received by the system indicates that the time of day is morning, specifically before or during a time in which the user may wish to purchase a breakfast item. In this situation, “breakfast” is used within this product title to optimize engagement based on the context of the time of day.

Beneath the product title, a concise product description is presented. It reads, “Enjoy your breakfast with our high-quality baguette.” This description serves to inform customers about the product's quality and its suitability for the specific time of day in which the user is viewing the product listing.

The depicted example illustrates how the inventive system generates and arranges visually appealing and informative creative content for product listings, taking into account contextual information to achieve an engagement objective such as a user purchasing the product that is presented. By combining imagery, promotional elements, and product titles and descriptions relevant to the user's context, the system aims to capture user interest and encourage engagement with the listed product. This visually enticing representation contributes to improved user experiences and enhanced marketing effectiveness within the platform.

FIG. 3B is a diagram illustrating the versatility of the model refinement approaches in generating product listings for different platforms or environments based on a product listing for a first platform. In the illustration, three different smartphones, each representing a client device, display user interfaces (hereinafter “UIs”) for three distinct platforms or environments. These platforms cater to different user preferences and engagement patterns.

On the first device, the product listing takes a prominent position at the top of the UI. This placement is specifically designed to showcase a sale or promotional offer related to the product. Below the product listing, other advertisements and product recommendations are displayed. This UI arrangement is optimized for users who are particularly responsive to discounts and promotions.

The second device's UI emphasizes the promotion for the product, positioning it at the top of the screen. In a similar format below, other promotions for various products are presented. This UI layout caters to users who are receptive to multiple promotional offers and might be interested in exploring various deals across different products.

The third device's UI prioritizes the product promotion, which appears prominently at the top. Below the product listing, the UI provides additional informational listings and visual content. This arrangement is ideal for users who prefer a more informative and detailed product presentation, allowing them to explore various aspects and related information.

The illustrated example underscores the adaptability of the methods and systems, which can dynamically generate product listings tailored to the unique characteristics and preferences of each platform. The generation process takes into account user engagement data for the user currently viewing the product listing and contextual information specific to the second platform or environment. As a result, the generated content is optimized to resonate with users on their respective platforms, enhancing engagement and increasing the likelihood of achieving desired engagement objectives.

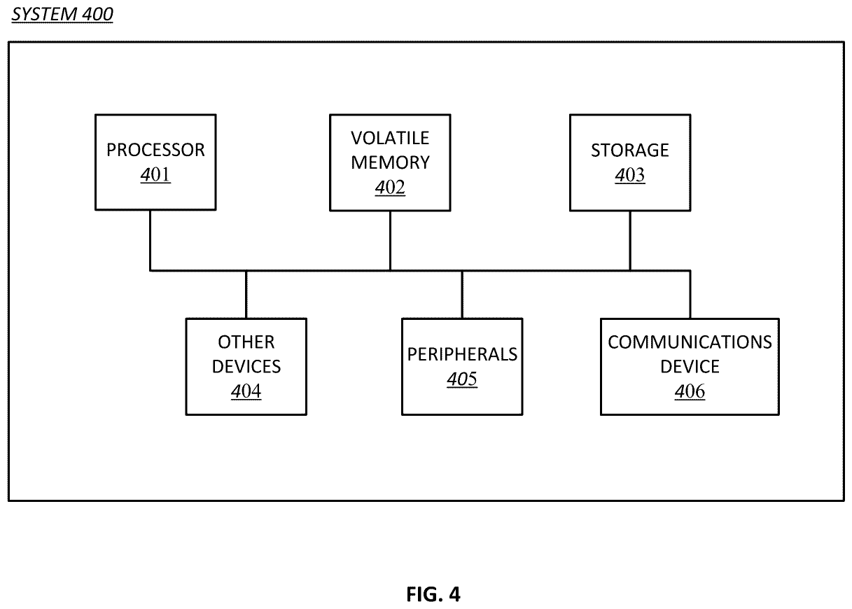

FIG. 4 is a diagram illustrating an exemplary computer that may perform processing in some embodiments. Exemplary computer 400 may perform operations consistent with some embodiments. The architecture of computer 400 is exemplary. Computers can be implemented in a variety of other ways. A wide variety of computers can be used in accordance with the embodiments herein.

Processor 401 may perform computing functions such as running computer programs. The volatile memory 402 may provide temporary storage of data for the processor 401. RAM is one kind of volatile memory. Volatile memory typically requires power to maintain its stored information. Storage 403 provides computer storage for data, instructions, and/or arbitrary information. Non-volatile memory, which can preserve data even when not powered and including disks and flash memory, is an example of storage. Storage 403 may be organized as a file system, database, or in other ways. Data, instructions, and information may be loaded from storage 403 into volatile memory 402 for processing by the processor 401.

The computer 400 may include peripherals 405. Peripherals 405 may include input peripherals such as a keyboard, mouse, trackball, video camera, microphone, and other input devices. Peripherals 405 may also include output devices such as a display. Peripherals 405 may include removable media devices such as CD-R and DVD-R recorders/players. Communications device 406 may connect the computer 100 to an external medium. For example, communications device 406 may take the form of a network adapter that provides communications to a network. A computer 400 may also include a variety of other devices 404. The various components of the computer 400 may be connected by a connection medium such as a bus, crossbar, or network.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “identifying” or “determining” or “executing” or “performing” or “collecting” or “creating” or “sending” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

Various general purpose systems may be used with programs in accordance with the teachings herein, or it may prove convenient to construct a more specialized apparatus to perform the method. The structure for a variety of these systems will appear as set forth in the description above. In addition, the present disclosure is not described with reference to any particular programming language. It will be appreciated that a variety of programming languages may be used to implement the teachings of the disclosure as described herein.

The present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing disclosure, implementations of the disclosure have been described with reference to specific example implementations thereof. It will be evident that various modifications may be made thereto without departing from the broader spirit and scope of implementations of the disclosure as set forth in the following claims. The disclosure and drawings are, accordingly, to be regarded in an illustrative sense rather than a restrictive sense.

What is claimed is:

1. A method for dynamically generating creative content for an e-commerce product listing, comprising:
receiving:
one or more initial pieces of creative content related to a first product listing for a product within a first platform, the one or more pieces of creative content being generated by a first generative artificial intelligence (AI) model;
user engagement data for a user of a second platform; and
one or more pieces of contextual information related to how the product will be viewed within the second platform;
using the one or more initial pieces of creative content, the user engagement data, and the one or more pieces of contextual information to train a refinement of a second generative AI model for dynamic creative content generation for a modified version of the first product listing for the second platform;
using the trained second generative AI model to generate one or more pieces of creative content for a second product listing to be published on the second platform;
displaying the one or more pieces of creative content for the second product listing to be viewed on the second platform via a client device associated with the user;
receiving feedback regarding user engagement with the pieces of creative content in terms of whether an engagement objective has been achieved; and
refining the first generative AI model and the second generative AI model based on the received feedback, the refinement being performed via a network of cross-refinement.

2. The method of claim 1, wherein the refining is performed to achieve the engagement objective for the second product listing being for a different product than for the first product listing.

3. The method of claim 1, wherein the refining is performed via one or more transfer learning techniques.

4. The method of claim 1, wherein the refining is performed to predict the likelihood that the user will interactively engage with the second product listing to achieve the engagement objective.

5. The method of claim 1, wherein the training involves backpropagating a loss function to predict the likelihood of the pieces of creative content resulting in achieving the engagement objective.

6. The method of claim 1, further comprising:
selecting, via a model trainer, the engagement objective to be achieved.

7. The method of claim 1, wherein the first generative AI model and second generative AI model are coupled together through an interface to generate cross-relevant creative content for the e-commerce listing.

8. The method of claim 1, wherein both the first generative AI model and the second generative AI model are used in sequence to generate creative content that is optimized for both the first and second platforms.

9. The method of claim 1, wherein a sequence of tokens is generated to minimize the loss function of both generative AI models to generate creative content that is personalized and contextually aware for the user across both the first and second platforms.

10. The method of claim 1, wherein the first and second generative AI models are each trained separately and then concatenated to generate the creative content for the e-commerce listing.

11. The method of claim 1, wherein each of the generative AI models have multiple tasks and multiple predictions for generating creative content.

12. The method of claim 1, wherein each of the first and second generative AI models generate separate objectives for generating or modifying the creative content to achieve the engagement objective across the first and second platforms.

13. The method of claim 1, wherein the first and second generative AI models are implemented to generate or modify creative content that achieves a standardized engagement objective between both generative AI models.

14. The method of claim 1, wherein the first and second generative AI models are used for generating creative content based on awareness of what other creative content is present for concurrent product listings within the respective platform.

15. The method of claim 1, wherein the creative content is dynamically generated or modified in real time to be competitive in achieving the engagement objective with other pieces of creative content in concurrent product listings within the second platform.

16. The method of claim 1, wherein at least one of the first and second generative AI models is a large language model (LLM).

17. The method of claim 1, wherein at least one of the first and second parts of the creative content comprises one or more of: a title, a description, and one or more images.

18. The method of claim 1, wherein the second generative AI model is configured to generate the creative content in order to deliver the creative content in a different context from an initial received context for the first product listing.

19. The method of claim 1, wherein the first and second generative AI models are configured to generate or modify creative content to be displayed in a cross-channel promotional product listing across a plurality of platforms.

20. A system comprising one or more processors configured to perform the operations of:
receiving:
one or more initial pieces of creative content related to a first product listing for a product within a first platform, the one or more pieces of creative content being generated by a first generative artificial intelligence (AI) model;
user engagement data for a user of a second platform, and
one or more pieces of contextual information related to how the product will be viewed within the second platform;
using the one or more initial pieces of creative content, the user engagement data, and the one or more pieces of contextual information to train a refinement of a second generative AI model for dynamic creative content generation for a modified version of the first product listing for the second platform;
using the trained second generative AI model to generate one or more pieces of creative content for a second product listing to be published on the second platform;
displaying the one or more pieces of creative content for the second product listing to be viewed on the second platform via a client device associated with the user;
receiving feedback regarding user engagement with the pieces of creative content in terms of whether an engagement objective has been achieved; and
refining the first generative AI model and the second generative AI model based on the received feedback, the refinement being performed via a network of cross-refinement.

21. A non-transitory computer-readable medium comprising:
instructions for receiving:
one or more initial pieces of creative content related to a first product listing for a product within a first platform, the one or more pieces of creative content being generated by a first generative artificial intelligence (AI) model;
user engagement data for a user of a second platform, and
one or more pieces of contextual information related to how the product will be viewed within the second platform;
instructions for using the one or more initial pieces of creative content, the user engagement data, and the one or more pieces of contextual information to train a refinement of a second generative AI model for dynamic creative content generation for a modified version of the first product listing for the second platform;
instructions for using the trained second generative AI model to generate one or more pieces of creative content for a second product listing to be published on the second platform;
instructions for displaying the one or more pieces of creative content for the second product listing to be viewed on the second platform via a client device associated with the user;
instructions for receiving feedback regarding user engagement with the pieces of creative content in terms of whether an engagement objective has been achieved; and
instructions for refining the first generative AI model and the second generative AI model based on the received feedback, the refinement being performed via a network of cross-refinement.
